(19) United States
(12) Patent Application Publication
(10) Pub. No.: US 2012/0216770 A1
(43) Pub. Date: Aug. 30, 2012

(54) MOBILE WORK MACHINE HAVING AN INTEGRATED STARTER GENERATOR

(75) Inventor: Marco Brun, Duesseldorf (DE)

(73) Assignee: Deutz Aktiengelellschaft, Koeln (DE)

(21) Appl. No.: 13/505,031

(22) PCT Filed: Dec. 14, 2010
(86) PCT No.: PCT/EP2010/007592

§ 371 Date: Apr. 30, 2012

(30) Foreign Application Priority Data
Dec. 17, 2009 (DE) 10 2009 058 712.8

(51) Int. Cl. F02N 11/04

(52) U.S. Cl. 123/179.28

(57) ABSTRACT

The invention relates to a mobile work machine, including at least one internal combustion engine (1), and an ISG (integrated starter generator) (4) for generating electric power and/or a torque. The ISG (4) includes at least one stator and at least one rotor, wherein the ISG (4) is operatively connected to the crankshaft of the internal combustion engine (1).

Electrical loads, such as magnets, heating devices and fan drives, which have substantial electrical power requirements, are often installed in mobile work machines. In conventional work machines, such electrical power is produced by generators that are either driven mechanically by a belt drive or hydraulically by a separate hydraulic motor.

### BACKGROUND

From the German Patent Application DE 199 55 311, a drive system for an industrial truck is known that has a drive device and at least one unit for working movements of the industrial truck, including an internal combustion engine, an infinitely variable speed variator coupled to the engine shaft, a common gear assembly, whose one input shaft is coupled directly to the shaft of the internal combustion engine, and whose second input shaft is coupled to the output shaft of the variator, an electric motor, whose shaft is coupled to a third input shaft of the common gear assembly, a switching gear between the output shaft of the common gear assembly and the drive wheels of the industrial truck, and a battery that is connected via a power electronics to the electric motor.

The inherent disadvantages of such approaches are that they are not very efficient, have a complex structural design, and entail additional costs.

### SUMMARY OF THE INVENTION

It is an object of the present invention to provide a possibility for high levels of electrical power, in particular for electrical loads in mobile work machines, to be supplied at reasonable costs, while improving efficiency and enhancing environmental compatibility.

The present invention provides that the electrical power is generated by a compact and integrated flywheel generator having substantially greater efficiency. In accordance with one advantageous embodiment, a conventional mobile work machine is provided that includes an internal combustion engine and a parallel configured electrical machine that spatially replaces the flywheel. The electrical machine generates electrical power via a power electronics, inter alia, for the most varied types of loads, such as, for example, a plank heating device as used in asphalt or road pavers. Electromagnets, as used, for example, in scrap-handling excavators or for other external loads, are connected via a three-phase socket-outlet or via a single-phase socket-outlet. The mobile work machine according to the present invention advantageously economizes fuel and space. A further advantage is that, by economizing space, room is created for an exhaust gas aftertreatment system, so that, in conjunction with the fuel-economizing effect, an enhanced environmental protection aspect comes into play.

### BRIEF DESCRIPTION OF THE DRAWINGS

FIG. 1: shows the control of a solenoid;

FIG. 2: shows the control of a plank heating;

FIG. 3: shows the control of a plank heating;

FIG. 4: shows a three-phase power supply system;

FIG. 5: is a schematic representation of a mobile work machine;

FIG. 6: is a block diagram of a mobile work machine.

### DETAILED DESCRIPTION

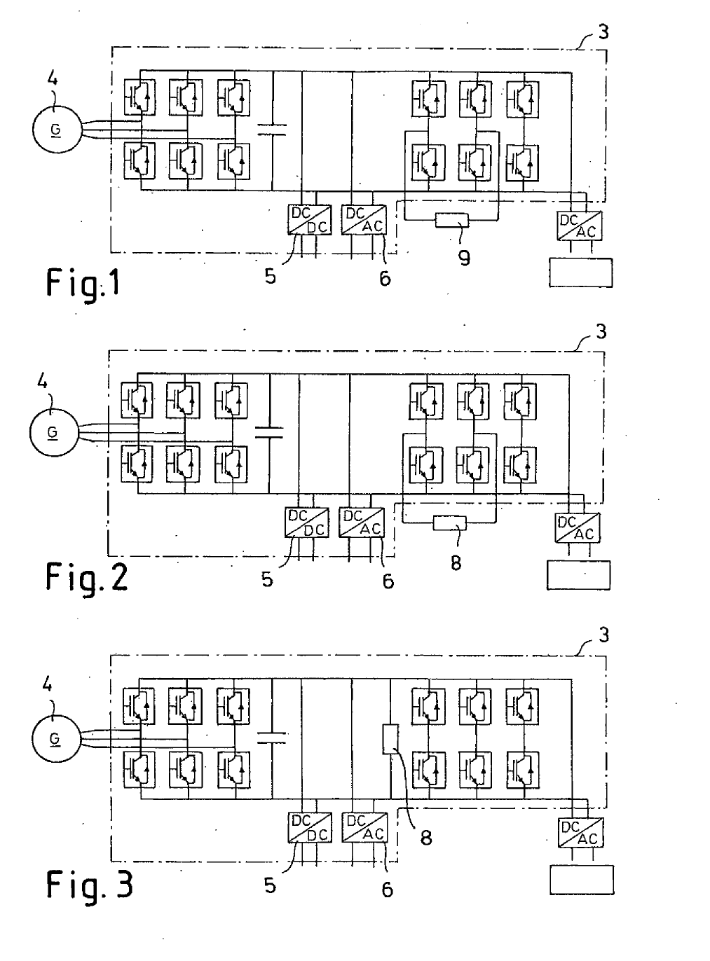

FIG. 1 illustrates the controlling of a solenoid using a variable-voltage DC intermediate circuit, an H-bridge for voltage reversal and current regulation to supply solenoid 9, DC/DC converter 5 for the 12 V electrical system, DC/AC converter 6 for 110, respectively 230 V, 50/60 Hz socket-outlet having a 16 A fuse and an external connection for further heavy-duty loads, such as an electrical fan in the DC intermediate circuit, for example.

FIG. 2 shows the controlling of a plank heating using a variable-voltage DC intermediate circuit, an H-bridge for current regulation featuring a superordinated control of temperature to supply plank heating 8, DC/DC converter 5 for the 12 V electrical system, DC/AC converter 6 for 110/230 V, 50, respectively 60 Hz socket-outlet having a 16 A fuse, an external connection for further heavy-duty loads, such as an electrical fan in the DC intermediate circuit, for example.

The alternative controlling of a plank heating is shown in FIG. 3; the current regulation being realized by a superordinated control of temperature to supply the plank heating using variable intermediate circuit voltage.

FIG. 4 shows a three-phase power supply system having a variable-voltage DC intermediate circuit. It provides a current-regulated three-phase 400 volt, 16/32/64 A electrical system for external electrical loads. In addition, it features a DC/DC converter 5 for the 12 V electrical system, a DC/AC converter 6 for a 110/230 volt, 50/60 Hz socket-outlet having a 16 A fuse. An external connection for further heavy-duty loads, such as an electrical fan in the DC intermediate circuit, for example, is also provided. In the case of asymmetrical loading of the power supply system, a fourth half bridge may be alternatively added to which the star point is connected. A further refinement according to the present invention provides that a portable lifting platform have such an internal combustion engine 1, including integrated starter generator 4 and power electronics 3, voltage transformers 5, 6 being configured in power electronics 3 in order to provide an independent power supply system for the lifting platform, for example to operate a steam jet cleaner thereon.

### Disconnecting Units in Dynamic Processes

To enhance the dynamic response of the drivetrain, an appropriate communication between the power electronics and the control unit of the diesel engine may be used to switch off those electrical loads for which this is possible from a technical standpoint. Thus, for example, when load is connected to the supply or in the case of sudden step changes in speed, the plank heating is deactivated for a limited period of time and immediately reactivated upon completion of the dynamic process.

### Feedback of the Electrical Energy to the Drivetrain

When solenoids 9 are used, it is imperative that the magnetic energy stored in the magnet be reduced as quickly as possible following de-energization thereof. In this case, resistors are often used in which the electrical energy is converted into thermal energy. In the present inventive system, the electrical energy may be fed back circuitously—ISG 4 is used as a generator—to an electrical energy accumulator 7, such as of an NiMh, LiPo or LiFePo accumulator, for example, or of a high-current capacitor and of the subsequent conversion in a load, for example as mechanical energy, to the drivetrain. The electrical energy is recuperated for this purpose, and there is no need for a separate resistor in which the energy is simply burned unnecessarily.

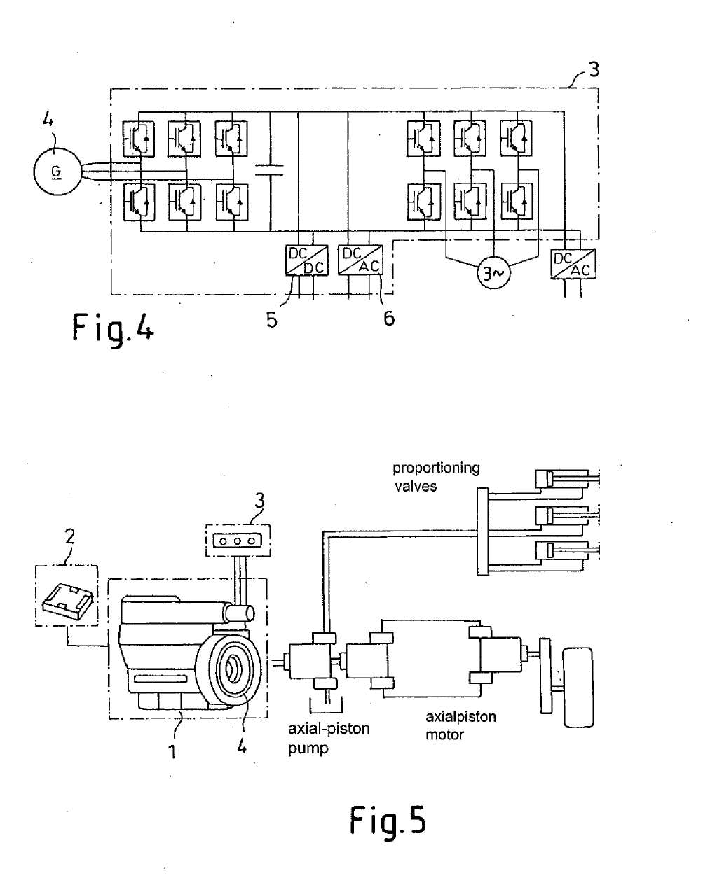

FIG. 5 shows a mobile work machine having an internal combustion engine 1, a control unit of internal combustion engine 1, and corresponding power electronics 3. Internal combustion engine 1 features what is generally referred to as an integrated starter generator 4 that has a stator and rotor and, in one operating state, functions as a starter of internal combustion engine 1; in another operating state, ISG 4 functions as a generator. In FIG. 5, it is discernible that ISG 4 is configured in place of the flywheels typical of internal combustion engines, advantageously rendering an otherwise necessary part replaceable and thereby economizing costs and the required installation space. The economized installation space may be used for other exhaust gas aftertreatment devices, such as DPF, SCR, AGR, AGR cooling, for example, that are not shown. The power electronics includes a DC/DC converter 5, as well as a DC/AC converter 6, an electrical energy store 7, possibly a heating device 8, a magnet 9, an electrical actuator 10, as well as an inverter 11.

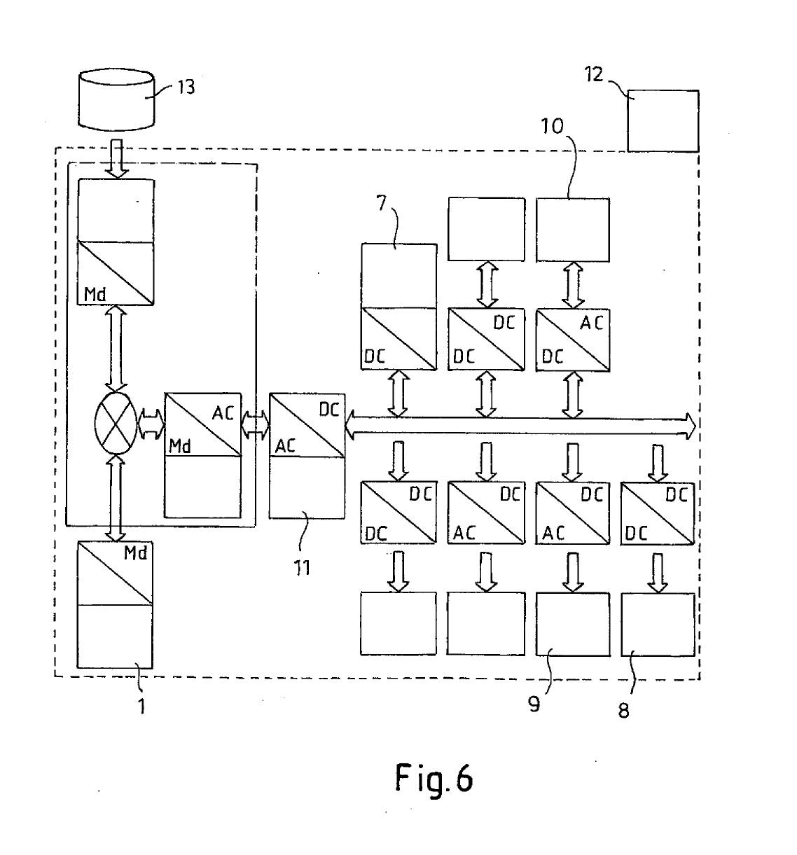

The system for operating mobile work machines, which is shown in FIG. 6 in the form of a block diagram, is designed to improve overall efficiency. The system control functions as a superordinated control in the control and regulation of all system components. The electrical machine is integrated in the internal combustion engine. The torques of the internal combustion engine, of the electrical machine, respectively of ISG 4 and of the drivetrain may be assigned according to demand. Electrical machine 4 is connected to an inverter 11. Inverter 11 supplies power to all of the electric loads. Inverter 11 supplies power to, respectively charges electrical energy store 7. Another electrical energy store may be alternatively provided, in particular when different voltages are required. The interfaces for the various loads, such as solenoid 9, actuator 10, the 12 volt DC connection, the 230,respectively 380 volt AC connection, the auxiliary systems, such as heating device 8, for example, may be completely or partially integrated in inverter 11. The energy stored in the loads, such as solenoid 9 and/or actuator 10 may be fed back to the drivetrain. The energy stored in the loads, such as solenoid 9 and/or actuator 10 may be fed back to electrical energy store 7. The energy stored in electrical energy store 7 may be used to assist internal combustion engine 1. The energy stored in electrical energy store 7 may be used to supply power to the loads, such as solenoid 9, actuator 10, the 12 volt DC connection, the 230/380 volt AC connection, the auxiliary systems or heating device 9. The energy stored in the drivetrain may be fed back to the electrical energy store via ISG 4. The energy stored in the drivetrain may be used to supply power to the electrical loads. The auxiliary systems may be operated according to demand. The 12 volt DC and the 230/380 volt AC connection may be used to supply power to the standard loads.

### LIST OF REFERENCE NUMERALS

1 internal combustion engine

2 control unit of internal combustion engine

3 power electronics

4 integrated starter generator

5 DC/DC converter

6 DC/AC converter

7 electrical energy store

8 heating device

9 magnet

10 electrical actuator

11 inverter

12 system control

13 fuel tank

What is claimed is:

1.-12. (canceled)

13. A mobile work machine comprising:
at least one internal combustion engine;
an ISG for generating electrical power and/or torque, the ISG having at least one stator and at least one rotor, the ISG being operatively connected to the crankshaft of the internal combustion engine.

14. The mobile work machine as recited in claim 13 further comprising at least one power electronics unit.

15. The mobile work machine as recited in claim 13 further comprising at least one 12 and/or 24 and/or 36 and/or 48 volt DC/DC converter.

16. The mobile work machine as recited in claim 15 wherein the Dc/DC converter is for an electrical system of the mobile work machine.

17. The mobile work machine as recited in claim 13 further comprising at least one DC/AC converter.

18. The mobile work machine as recited in claim 17 wherein the DC/AC converter is for a 110/230/380 volt power supply system.

19. The mobile work machine as recited in claim 13 further comprising at least one electrical energy store.

20. The mobile work machine as recited in claim 13 further comprising at least one heating device.

21. The mobile work machine as recited in claim 13 further comprising at least one solenoid.

22. The mobile work machine as recited in claim 13 further comprising at least one actuator.

23. The mobile work machine as recited in claim 22 wherein the actuator is an electrical actuator.

24. The mobile work machine as recited in claim 13 further comprising at least one auxiliary system.

25. The mobile work machine as recited in claim 13 further comprising at least one hydraulic system having at least one pump and at least one load.

26. The mobile work machine as recited in claim 25 further comprising at least one linear and/or rotary motor.

27. A method for operating mobile work machines, comprising operating the mobile work machine as recited in claim 13.
